(19) United States
(12) Patent Application Publication
(10) Pub. No.: US 2018/0299561 A1
(43) Pub. Date: Oct. 18, 2018

(54) TECHNIQUES OF CAPTURING GNSS SIGNALS AT REQUESTED TIMING

(71) Applicant: Mediatek Inc., Hsin-Chu (TW)

(72) Inventors: Pei-Hung Jau, Tainan (TW); Hung-Jen Chen, Tainan (TW)

(21) Appl. No.: 15/866,665

(22) Filed: Jan. 10, 2018

Related U.S. Application Data
(60) Provisional application No. 62/486,025, filed on Apr. 17, 2017.

(51) Int. Cl. G01S 19/25; H04B 1/7073; G01S 19/39

(52) U.S. Cl. CPC G01S 19/256; G01S 19/39; H04B 1/7073

(57) ABSTRACT

A UE may employ two independent oscillators to provide timing to GNSS components and communication components, respectively. To perform a time measurement of the GNSS signals and a time measurement of the communication signals at the exact same time point, in an aspect of the disclosure, a method, a computer-readable medium, and an apparatus are provided. The apparatus a UE. The UE synchronizes, at a first time point, first system time of a wireless communication component of the UE and second system time of a GNSS component of the UE. The UE further measures a GNSS signal at a second time point subsequent to the first time point to obtain a first GNSS signal measurement. The UE estimates a second GNSS signal measurement of the first time point based on the first GNSS signal measurement and a first time period between the first time point and the second time point.

### CROSS-REFERENCE TO RELATED APPLICATION(S)

This application claims the benefit of U.S. Provisional Application Ser. No. 62/486,025, entitled “METHOD TO CAPTURE GNSS SIGNAL AT THE EXACT TIMING REQUESTED BY EXTERNAL SOURCE” and filed on Apr. 17, 2017, which is expressly incorporated by reference herein in its entirety.

### BACKGROUND

### Field

The present disclosure relates generally to communication systems, and more particularly, to user equipment (UE) that can capture Global Navigation Satellite System (GNSS) signals at a time point that is within a small range (e.g., 100, 200, 300, 500, 700, 900 nanoseconds, etc.) from a requested time point.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology.

To perform positioning of a UE that is accessing one or more wireless cellular networks (e.g., a cellular telephone network), several approaches perform trilateration based upon the use of timing information sent between each of several base stations and the UE, such as a cellular telephone. With approaches such as Advanced Forward Link Trilateration (AFLT) in CDMA, Enhanced Observed Time Difference (E-OTD) in GSM, and Observed Time Difference of Arrival (OTDOA) in Wideband Code Division Multiple Access (WCDMA) and LTE, the UE measures the relative times of arrival of signals transmitted from each of several base stations. These times can be transferred to a location server (e.g., a position determination Entity (PDE) in CDMA or an evolved serving mobile location center (E-SMLC) in LTE), which computes the position of the mobile station using these times of reception. The transmit times at these base stations are coordinated such that at a particular instance of time, the times-of-day associated with multiple base stations are within a specified error bound. The accurate positions of the base stations and the times of reception are used to determine the position of the mobile station.

Further, a combination of a base station based positioning system (e.g., OTDOA) with a satellite positioning system (SPS) system may be referred to as a “hybrid” system. In a hybrid system, the position of a cell based transceiver is determined from a combination of at least: i) a time measurement that represents a time of travel of a message in the cell based communication signals between the cell based transceiver and a communication system; and ii) a time measurement that represents a time of travel of an SPS signal. Thus, there is a need for a mechanism that can take a time measurement of a base station based positioning system and a time measurement of an SPS within a small time period (e.g., 100, 200, 300, 500, 700, 900 nanoseconds, etc.).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

For purposes of performing hybrid positioning, a UE needs to measure GNSS signals (e.g., GPS signals) at the exact timing corresponding to a frame of another communication system (e.g., LTE, CDMA) of the UE. The UE, however, may employ two independent oscillators to provide timing to the GNSS components and the communication components, respectively. Therefore, it is challenging to perform a time measurement of the GNSS signals and a time measurement of the communication signals at the exact same time point.

In an aspect of the disclosure, a method, a computer-readable medium, and an apparatus are provided. The apparatus a UE. The UE synchronizes, at a first time point, first system time of a wireless communication component of the UE and second system time of a global navigation satellite system (GNSS) component of the UE. The UE further measures a GNSS signal at a second time point subsequent to the first time point to obtain a first GNSS signal measurement. The UE estimates a second GNSS signal measurement of the first time point based on the first GNSS signal measurement and a first time period between the first time point and the second time point.

Accordingly and as described infra, in certain configurations, the UE may obtain a time synchronization within hundreds of nanoseconds (e.g., 100, 200, 300, 500, 700, 900 nanoseconds, etc.) between the communication components and the GNSS components of the UE. As such, the UE may generate a GNSS measurement right on a real frame boundary or a positioning reference signal of a communication frame received by the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 shows an example of an OTDOA system.

FIG. 4 is a block diagram of a base station in communication with a UE in an access network.

FIG. 5 shows one example of a hybrid positioning system.

FIG. 6 shows another example of a hybrid positioning system.

FIG. 7 is a diagram illustrating a sequence of operations for synchronizing/correlating a communication system time with a GNSS system time of a UE.

FIG. 8 is diagram illustrating a UE that takes a communication signal measurement and a GNSS signal measurement.

FIG. 9 is a flow chart of a method (process) for estimating a GNSS signal measurement at a particular time point.

FIG. 10 is a flow chart of a method (process) for synchronizing/correlating a communication system time with a GNSS system time.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced.

The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. , (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

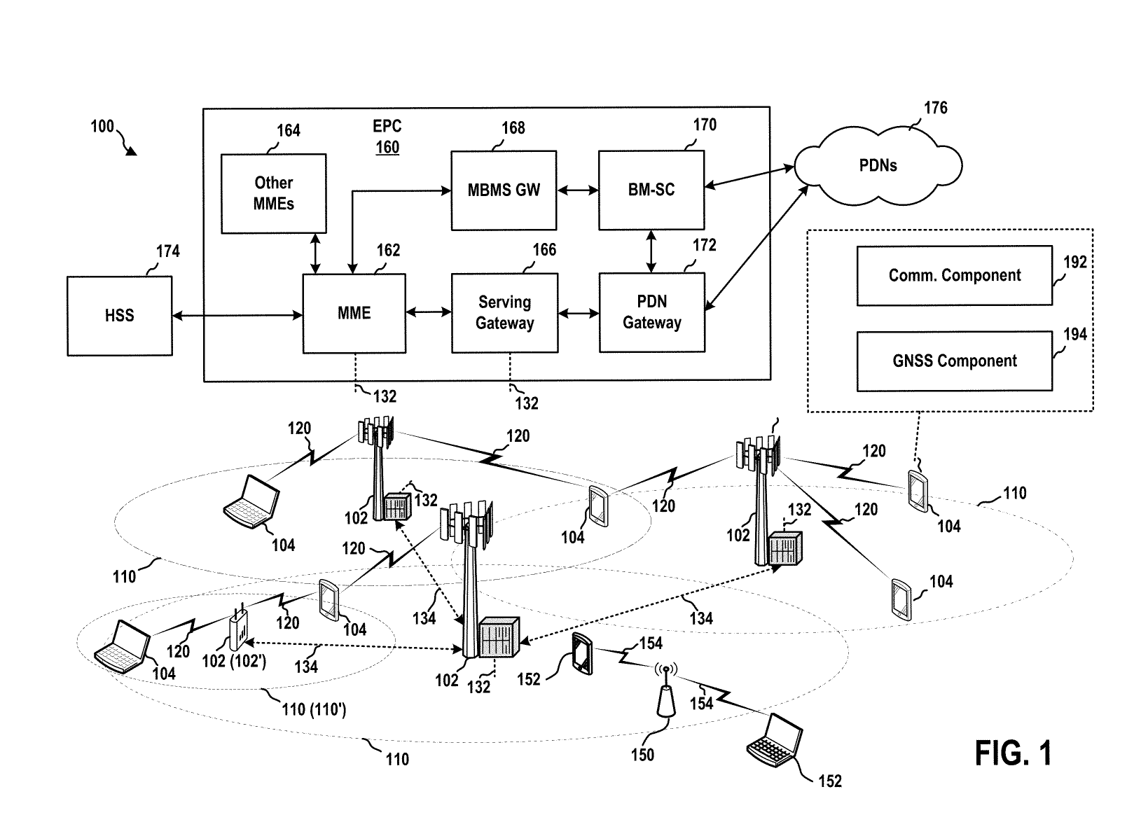

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., 51 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the packet data networks 176. The packet data networks 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB or eNodeB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device.

The UE 104 may also be referred to as a station, a UE, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to include a communication component 192 and a GNSS component 194. In certain configurations, the communication component 192 and the GNSS component 194 synchronize, at a first time point, first system time of the communication component 192 and second system time of the GNSS component 194. The GNSS component 194 measure a GNSS signal at a second time point subsequent to the first time point to obtain a first GNSS signal measurement. The GNSS component 194 further estimates a second GNSS signal measurement of the first time point based on the first GNSS signal measurement and a first time period between the first time point and the second time point.

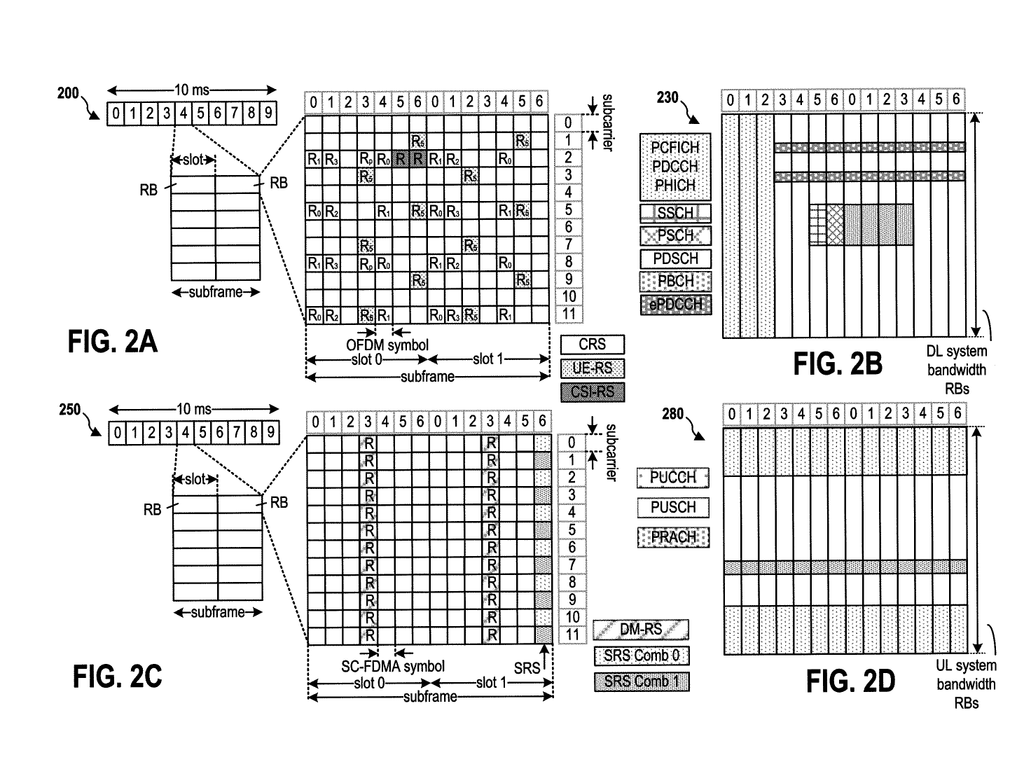

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). Further, FIG. 2A also illustrates two of multiple positioning reference signals (indicated as Rₚ).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (HACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

To perform positioning of a UE that is accessing one or more wireless cellular networks (e.g., a cellular telephone network), several approaches perform trilateration based upon the use of timing information sent between each of several base stations and a UE, such as a cellular telephone. One approach, called Advanced Forward Link Trilateration (AFLT) in CDMA, Enhanced Observed Time Difference (E-OTD) in GSM, or Observed Time Difference of Arrival (OTDOA) in WCDMA and LTE, measures at the UE the relative times of arrival of signals transmitted from each of several base stations. These times can be transferred to a location server (e.g., a position determination Entity (PDE) in CDMA or an evolved serving mobile location center (E-SMLC) in LTE), which computes the position of the UE using these times of reception. The transmit times at these base stations are coordinated such that at a particular instance of time, the times-of-day associated with multiple base stations are within a specified error bound. The accurate positions of the base stations and the times of reception are used to determine the position of the UE.

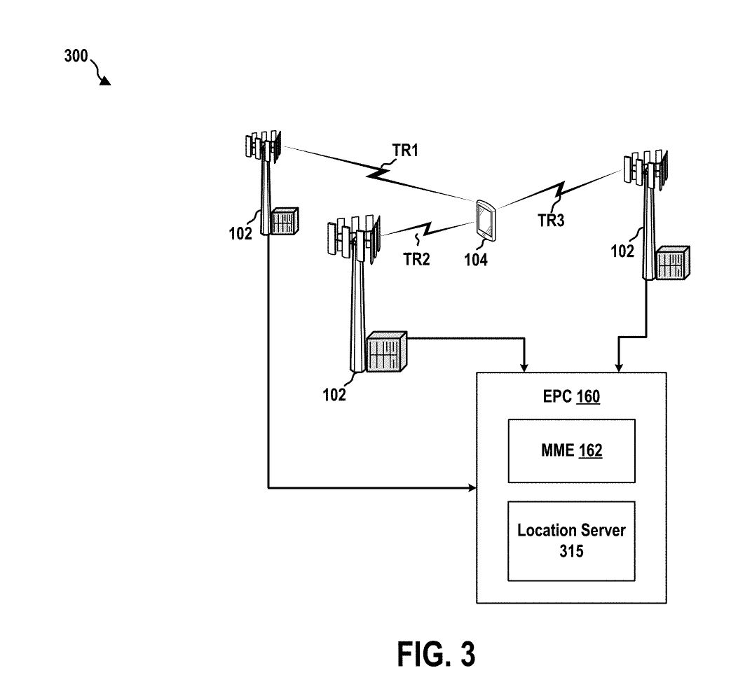

FIG. 3 shows an example of an OTDOA system where the times of reception (TR1, TR2, and TR3) of positioning reference signals from base stations 102 are measured at the UE 104. This timing data may then be used to compute the position of the UE 104. Such computation may be done at the UE 104 or at a location server 315 if the timing information so obtained by the UE 104 is transferred to the location server 315. The location server 315 may be an E-SMLC. Typically, the times of receptions are communicated to a location server 315 through one of the base stations 102. The location server 315 is coupled to receive data from the base stations 102 through one or more MME 162. The location server 315 may include a base station almanac (BSA) server, which provides the location of the base stations 102 and/or the coverage area of the base stations 102 and/or any small differences in signal transmission times between any pair of the base stations 102. Alternatively, the location server 315 and the BSA server may be separate from each other; and the location server 315 communicates with the base station 102 to obtain the base station almanac for position determination. In certain configurations, the location server 315 may also monitor transmissions from several of the base stations 102 either directly or using external measurement units in an effort to determine the relative timing of these transmissions.

In another approach, called Uplink Time of Arrival (UTOA), the times of reception of a signal from a UE 104 are measured at several base stations 102. FIG. 3 applies to this case if the arrows of TR1, TR2, and TR3 are reversed. This timing data may then be communicated to the location server 315 to compute the position of the UE 104.

Yet a third method of doing position location involves the use in the UE 104 of circuitry for the United States Global Positioning Satellite (GPS) system or other Satellite Positioning Systems (SPS), such as the Russian GLONASS system and the proposed European Galileo System or a combination of satellites and pseudolites.

Further, pseudolites are ground-based transmitters, which broadcast a PN code (similar to a GPS signal) modulated on an L-band carrier signal, generally synchronized with SPS time. Each transmitter may be assigned a unique PN code so as to permit identification by a UE 104. Pseudolites are useful in situations where SPS signals from an orbiting satellite might be unavailable, such as tunnels, mines, buildings or other enclosed areas.

The term “satellite,” as used herein, is intended to include pseudolites or equivalents of pseudolites. The term GPS signals, as used herein, is intended to include SPS signals, and SPS-like signals from pseudolites or equivalents of pseudolites. Similarly, the terms GPS satellite and GPS receiver, as used herein, are intended to include other SPS satellites and SPS receivers. Methods that use an SPS receiver to determine a position of a UE 104 may be completely autonomous (in which the SPS receiver, without any assistance, determines the position of the UE 104) or may utilize the wireless network to provide assistance data or to share in the position calculation.

For instance, in one technique, accurate time information is obtained from cellular phone transmission signals and is used in combination with SPS signals to determine the position of the receiver. In another technique, Doppler frequency shifts of in-view satellites is transmitted to the receiver on the UE 104 to determine the position of the UE 104. In yet another technique, satellite almanac data (or ephemeris data) is transmitted to a receiver to help the receiver to determine its position. In another technique, a precision carrier frequency signal of a cellular telephone system is locked to provide a reference signal at the receiver for SPS signal acquisition. In another technique, an approximate location of a receiver is used to determine an approximate Doppler for reducing SPS signal processing time. In one technique, different records of a satellite data message received are compared to determine a time at which one of the records is received at a receiver in order to determine the position of the receiver. In certain implementations, both the mobile cellular communications receiver and the SPS receiver are integrated into the same enclosure and may in fact share common electronic circuitry.

In yet another variation of the above methods, the round trip delay (RTD) is found (e.g., by the base station 102) for signals that are sent from the base station 102 to the UE 104 and then are returned. In a similar, but alternative, method the round trip delay is found (e.g., by a UE 104) for signals that are sent from the UE 104 to the base station 102 and then returned. Each of these round-trip delays is divided by two to determine an estimate of the one-way propagation delay. Knowledge of the location of the base station 102, plus a one-way delay constrains the location of the UE 104 to a circle on the earth. Two such measurements from distinct base stations 102 then result in the intersection of two circles, which in turn constrains the location to two points on the earth. A third measurement (even an angle of arrival or cell sector identification) resolves the ambiguity.

A combination of either the OTDOA or U-TDOA with an SPS system may be referred to as a “hybrid” system. In a hybrid system, the position of a cell based transceiver is determined from a combination of at least: i) a time measurement that represents a time of travel of a message in the cell based communication signals between the cell based transceiver and a communication system; and ii) a time measurement that represents a time of travel of an SPS signal.

Altitude aiding has been used in various methods for determining the position of a UE 104. Altitude aiding is typically based on a pseudo-measurement of the altitude. The knowledge of the altitude of a location of a UE 104 constrains the possible positions of the UE 104 to a surface of a sphere (or an ellipsoid) with its center located at the center of the earth. This knowledge may be used to reduce the number of independent measurements required to determine the position of the UE 104. For example, an estimated altitude may be determined from the information of a cell object, which may be a cell site that has a cell site transmitter in communication with the UE 104.

Position determination techniques to determine an estimated position described herein may be implemented in conjunction with various wireless communication networks such as a wireless wide area network (WWAN), a wireless local area network (WLAN), a wireless personal area network (WPAN), and so on. The terms “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE) network, a WiMAX (IEEE 802.16) network, and so on.

A CDMA network may implement one or more radio access technologies (RATs) such as cdma2000, Wideband-CDMA (W-CDMA), and so on. Cdma2000 includes IS-95, IS-2000 and IS-856 standards. A TDMA network may be implemented with a Global System for Mobile Communications (GSM) system, Digital Advanced Mobile Phone System (D-AMPS), or some other radio access technology (RAT). GSM, W-CDMA and LTE standards are described in documents from a consortium named “3^{rd} Generation Partnership Project” (3GPP). The cdma2000 standard is described in documents from a consortium named “3^{rd} Generation Partnership Project 2” (3GPP2). 4GPP and 4GPP2 documents are publicly available. WLAN may be implemented with an IEEE 802.11x standards. WPAN may be implemented with a Bluetooth, an IEEE 802.15x, or other standard. The techniques may also be implemented in conjunction with any combination of WWAN, WLAN and/or WPAN.

A satellite positioning system (SPS) typically includes a system of transmitters positioned to enable entities to determine their location on or above the Earth and are based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of a Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using a PN code with different phases, using different PN codes for each satellite as in GPS, or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems (e.g., Quasi-Zenith Satellite System (QZSS) over Japan, Indian Regional Navigational Satellite System (IRNSS) over India, Beidou over China, etc.) and/or various augmentation systems (e.g., an Satellite Based Augmentation System (SBAS)) that may be associated with or otherwise enabled for use with one or more global and/or regional navigation satellite systems. By way of example but not limitation, an SBAS system may include one or more augmentation systems that provide integrity information, differential corrections, etc. (e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like). Thus, as used herein SPS or GPS may include any combination of one or more global and/or regional navigation satellite systems and/or augmentation systems, and SPS signals may include SPS, SPS-like, and/or other signals associated with such one or more SPS.

As used herein, a UE 104, refers to a device such as a mobile device, a cellular phone or other wireless communication device, personal communication system (PCS) device, personal navigation device (PND), Personal Information Manager (PIM), Personal Digital Assistant (PDA), laptop, tablet, smartbook, smartphone, netbook, or other suitable device that is capable of receiving wireless communication and/or navigation signals. The term UE is also intended to include devices that communicate with a personal navigation device (PND), such as by short-range wireless, infrared, wireline connection, or other connection, regardless of whether satellite signal reception, assistance data reception and/or position-related processing occurs at the UE 104 or remotely. Also, a UE 104 includes all devices, including wireless communication devices, computers, laptops, etc. that are capable of communication with a server via the Internet, Wi-Fi, or other network, and regardless of whether satellite signal reception, assistance data reception, and/or position-related processing occurs at the UE 104, at a server, or at another device associated with the network. Any operable combination of the above are also considered a UE. A UE may also be referred to as a user equipment (UE).

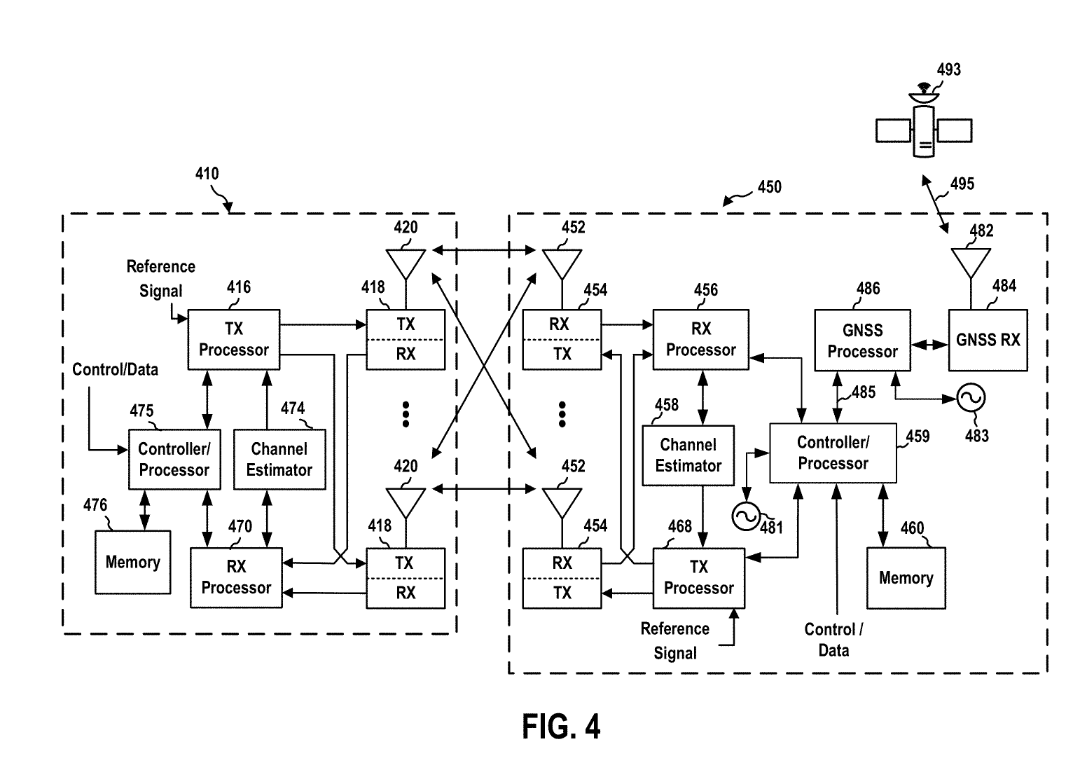

FIG. 4 is a block diagram of an eNB 410 in communication with a UE 450 in an access network. In the DL, IP packets from the EPC 160 may be provided to a controller/processor 475. The controller/processor 475 implements layer 3 and layer 2 functionality. layer 3 includes a radio resource control (RRC) layer, and layer 2 includes a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate an RF carrier with a respective spatial stream for transmission.

At the UE 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 410. These soft decisions may be based on channel estimates computed by the channel estimator 458. The soft decisions are then decoded and deinterleaved to recover the data and control signals that were originally transmitted by the eNB 410 on the physical channel. The data and control signals are then provided to the communication processor 459, which implements layer 3 and layer 2 functionality.

The communication processor 459 can be associated with a memory 460 that stores program codes and data. The memory 460 may be referred to as a computer-readable medium. In the UL, the communication processor 459 provides demultiplexing between transport and logical channels, packet reassembly, deciphering, header decompression, and control signal processing to recover IP packets from the EPC 160. The communication processor 459 is also responsible for error detection using an ACK and/or NACK protocol to support HARQ operations.

Similar to the functionality described in connection with the DL transmission by the eNB 410, the communication processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 458 from a reference signal or feedback transmitted by the eNB 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The UL transmission is processed at the eNB 410 in a manner similar to that described in connection with the receiver function at the UE 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

Although FIG. 4 shows an exemplary eNB 410, other base stations 102, such as a wireless LAN access point (AP), a femtocell, etc., may provide access point base station signals over an access point communication link. The communication antennas 452 may be adapted to receive signals from different types of base stations 102 (e.g., cellular base stations and wireless LAN access points). Communication signal processing modules of the UE 450 may use separate and distinct antennas for receiving signals of different air interfaces. The communication signal processing modules may include the communication antennas 452, the RX processors 456, the TX processors 468, and the communication processor 459. Further, the communication signal processing modules may use separate and distinct components for at least partial processing of the received wireless signals and may or may not share some components in the processing of the wireless signals of different air interfaces. For example, the communication signal processing modules may have separate circuits for the RF signal processing and share same data processor resources. The communication signal processing modules may be implemented as multiple receivers and transmitters for different wireless networks. For example, the communication signal processing modules may include a transceiver portion for receiving and/or transmitting cellular telephone signals and another transceiver portion for receiving and/or transmitting Wi-Fi signals. The communication signal processing modules is coupled to communication antenna 452. From this description, various combinations and variations of the combined receiver will be apparent to one skilled in the art.

The UE 450 further includes a GNSS receiver 484. The GNSS receiver 484 processes GNSS signals, which are generated from GNSS satellites 493. The GNSS receiver 484 includes a GPS acquisition and tracking circuit, which is coupled to a GNSS antenna 482. GNSS signals (e.g., from a satellite communication link 495 transmitted from GNSS satellites 493) are received through the GNSS antenna 482 and the GNSS receiver 484, and input to the GNSS processor 486, which acquires the PN (pseudorandom noise) codes for various GNSS satellites 493. The data produced by the GNSS processor 486 (e.g., correlation indicators) may be further processed by communication processor 459 for transmittal (e.g., of GPS pseudoranges) by the communication signal processing modules. The communication signal processing modules may act as a means for receiving communication signals, such as assistance data, from a wireless network.

In one embodiment of the present invention, the communication signal processing modules are capable of being used with a number of different air interfaces (e.g., IEEE 802.11, Bluetooth, UWB, TD-SCDMA, iDEN, HDR, TDMA, GSM, CDMA, W-CDMA, UMTS, LTE, WiMAX, or other similar networks) for communication (e.g., through a cellular base station communication link or an access point communication link). In one embodiment of the present invention, the communication signal processing modules are capable of being used with one air interface for communication and capable of being used to receive signals with other air interfaces. In one embodiment of the present invention, the communication signal processing modules are capable of being used with one air interface for communication while also being capable of being used with signals in another air interface to extract timing indicators (e.g., timing frames or system time) or to calibrate a local oscillator of the UE 450.

In certain configurations of the UE 450, location data generated by the GNSS receiver 484 is transmitted to a server over a cellular base station communication link or over an access point communication link. A location server 315 then determines the location of the UE 450 based on the location data from the UE 450, the time at which the location data were measured and ephemeris data received from the GNSS receiver 484 or other sources of such data. The location data can then be transmitted back to communication signal processing modules in the UE 450 or to other remote locations.

Further, the UE 450 also includes an oscillator 481 that is in communication with the communication processor 459. The oscillator 481 provides timing information to the communication signal processing modules through the communication processor 459. The UE 450 further includes an oscillator 483 that is in communication with the GNSS processor 486. The oscillator 483 provides timing information to the GNSS processor 486. Further, the oscillator 481 and oscillator 483 operate independently from each other. That is, the timing provided by one oscillator may not be in synchronization with the other oscillator. To solve this problem, the communication processor 459 is in communication with the GNSS processor 486 through a synchronization link 485. As described infra, the communication processor 459 can send a synchronization signal to the GNSS processor 486 through the synchronization link 485.

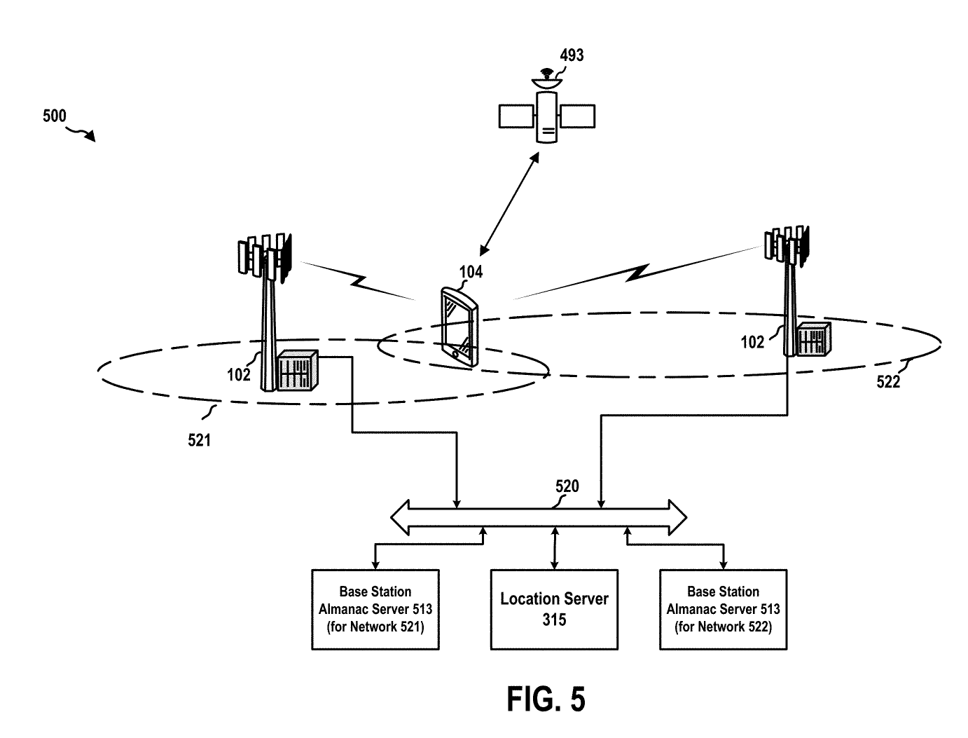

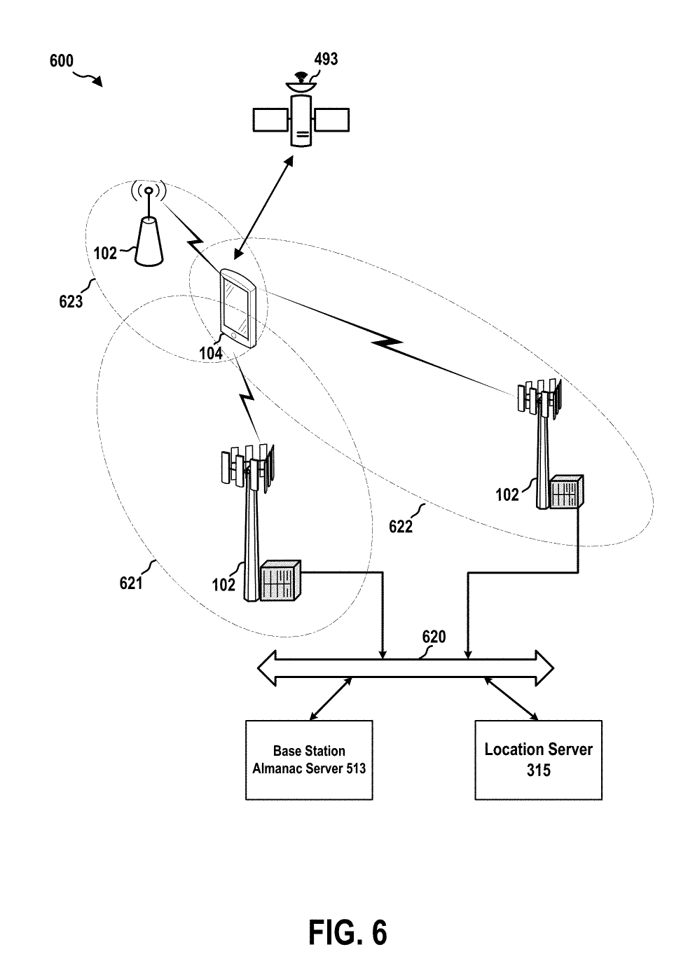

FIG. 5 shows one example of a hybrid positioning system. For position determination, a UE 104 receives signals from a base station 102 (e.g., a cellular base station) of a wireless network 521, a base station 102 (e.g., a cellular base station) of a wireless network 522, and/or a base station 102 (e.g., an access point) of a wireless network 623 (FIG. 6). As described supra, the UE 104 includes a GNSS receiver 484 for receiving GNSS signals from GNSS satellites 493. Also, the UE 104, in determining timing measurements, may make base station timing measurements (e.g., pseudorange, round trip time, times of arrival of signals and/or time differences of arrival of signals), which are based on the GNSS signals and/or the wireless signals from one or more of the wireless network 521, the wireless network 522, and the wireless network 623.

The timing measurements may be used to determine the position of the UE 104. It is understood that, in general, each of the wireless network 521, the wireless network 522, and the wireless network 623 may include a number of base stations 102 (e.g., cellular base stations or wireless access points) and may operate with different specification. For example, the wireless network 521 and the wireless network 522 may use the same type of air interface but operated by different service providers. The wireless network 521 and the wireless network 522 may operate with the same communication protocols but at different frequencies. The wireless network 521 and the wireless network 522 may be from different service providers using different types of air interfaces (e.g., TDMA, GSM, CDMA, W-CDMA, UMTS, LTE, WiMAX, TD-SCDMA, iDEN, HDR, Bluetooth, UWB, IEEE 802.11 or other similar networks). Alternatively, the wireless network 521 and the wireless network 522 may be operated by the same service provider but use different types of air interfaces.

The UE 104 communicates information extracted from the GNSS signals from the GNSS satellites 493 and information extracted from the base stations 102 to a location server 315. The information from the GNSS signals may include pseudorange measurements and/or a record of a GPS message for comparison to determine a time of signal reception. The information from the base stations 102 may include identification, received signal strength and/or round-trip or one-way time measurements for at least one of the base stations 102. In some embodiments, this information is communicated to the location server 315 through one of the wireless networks, such as the wireless network 521 or the wireless network 522. For example, the information is communicated to the location server 315 when the UE 104 is attached or is a subscriber of the wireless network 522 but not a subscriber of a wireless network 521.

The location server 315 may be combined as a single location server 315 for multiple wireless networks. Alternatively, the location server 315 may be separated such that one location server 315 exists for each wireless network.

Further, a first base station almanac server 513 maintains the almanac data for the wireless network 521 and a second base station almanac server 513 maintain the almanac data for the wireless network 522. Alternatively, a base station almanac server 513 may maintain the almanac data for both the wireless network 521 and the wireless network 522. This almanac data may simply be, in one exemplary implementation, a database listing a latitude and longitude for each base station 102, which is specified by identification information.

The location server 315 may use the information communicated from the UE 104 and the data in the almanac from one or both networks to determine the position of the UE 104. The location server 315 may determine the location of the UE 104 in a number of different ways. For example, the location server 315 may retrieve the locations of base stations 102 from the first base station almanac server 513 for the wireless network 521 and/or the second base station almanac server 513 for the wireless network 522. The location server 315 may use the retrieved locations, the range measurements (which indicate a distance between the UE 104 and base stations 102), the GPS pseudorange measurements, and the GPS ephemeris information, to calculate a position of the UE 104. Further, range measurements from a single wireless network and GPS pseudorange measurements may be combined to calculate an estimated position of a UE 104. Alternatively, the location server 315 may use only terrestrial range measurements (or other types of measurements such as signal strength measurements) to multiple wireless access points of multiple wireless networks to calculate the estimated position if many (e.g., more than 4) of such range measurements can be made; in this case, there is no need to obtain GPS pseudoranges or GPS ephemeris information. If GPS pseudoranges to GNSS satellites 493 are available, these pseudoranges can be combined with GPS ephemeris information, obtained either by the UE 104 or by a collection of GPS reference receivers, to provide additional information in the estimated position calculations.

A backbone network 520 may include local area networks, one or more intranets and the Internet for the information exchange between the various entities. It is understood that the location server 315, the first base station almanac server 513 (for the wireless network 521) and the second base station almanac server 513 (for the wireless network 522) may be implemented as a single server program or different server programs in a single data processing system or in separate data processing systems (e.g., maintained and operated by different service providers). Different service providers may operate the wireless network 521 and the wireless network 522, which are used by the UE 104 for estimated position determination. A UE 104 may be a subscriber only to one of the wireless networks, and thus the UE 104 may be authorized to use (and to have access to) only one wireless network. However, it may be possible to receive signals from the wireless network that is not subscribed to and thus it is possible to make range measurements or signal strength measurements relative to wireless access points in the wireless network that is not subscribed to.

One specific example of this situation involves a UE 104 that includes a tri-mode CDMA cellular phone, which can receive PCS frequency band signals from two service providers. For example, the UE 104 has the capability to receive and process signals from a wireless network 521, operated by a first service provider, and from a wireless network 522, operated by a second service provider but the user must subscribe with both service providers. If the user only subscribes to the first service provider but not the second service provider, the UE 104 for that user is authorized to operate with the wireless network 521 but not with the wireless network 522. If the UE 104 is in an environment in which only one base station 102 from the wireless network 521 is available and capable of radio communication with the UE 104 but numerous base stations 102 from the wireless network 522 are within radio communication range of the UE 104, the UE 104 may obtain satellite assistance data (if desired) from a location server 315 through the one base station 102 from the wireless network 521. The UE 104 may transmit GPS pseudoranges, obtained at the UE 104, to the location server 315 through the one base station 102 from the wireless network 521. However, it will not be possible to obtain more than one range measurement to another base station 102 unless range measurements to one or more base stations 102 from the wireless network 522 are obtained. Thus, the UE 104 may obtain range measurements to available base stations 102 from the wireless network 522, thereby providing multiple range measurements (e.g., distances between the UE 104 and two base stations 102 from the wireless network 522), which can be used in the estimated position calculations.

The service providers may separately maintain the almanac information on a first base station almanac server 513 for a wireless network 521 and a second base station almanac server 513 for a wireless network 522. Although the UE 104 has communication access to only one of the wireless networks, the location server 315 may have access to both the first base station almanac server 513 and the second base station almanac server 513. After determining the identities of base stations 102 (e.g., wireless access points) of both the wireless network 521 and the wireless network 522, the UE 104 transmits the base station identification information to the location server 315, which uses first and second base station almanac servers 513 to retrieve the positions of the corresponding base stations 102, which can be used in determining the estimated position of the UE 104.

Alternatively, the cooperation between the service providers to share almanac data is not necessary. For example, the operator of the location server 315 maintains both a first base station almanac server 513 (for the wireless network 521) and a second base station almanac server 513 (for the wireless network 522). For example, an operator may maintain a base station almanac server 513 through a survey process to obtain the almanac data or through a data harvesting process using UEs 104.

The UE 104 may use both a wireless network 521 and a wireless network 522 for communicating with the location server 315 (instead of using only one of the wireless networks for communication purpose). As known in the art, various types of information can be exchanged between the UE 104 and the location server 315 for estimated position determination. For example, the location server 315 provides the UE 104 with Doppler frequency shift information for GNSS satellites 493 in view by the UE 104 (e.g., through the wireless network 521). Next, the UE 104 provides pseudorange measurements for GNSS signals, the identification information of the base stations 102 and associated range measurements (e.g., round-trip time measurements) to the location server 315 through the wireless network 522 for calculation of the estimated position of the UE 104.

The UE 104 may be capable of communicating through more than one wireless network to the location server 315 when in the coverage area of these wireless networks. However, the trade-off between cost and performance may dictate communication with the server using just one of the wireless networks, while using the wireless network(s) to obtain measurements (e.g., timing measurements or received signal levels) or other information (e.g., time information for time stamping measurements or calibration information for locking to an accurate carrier frequency or for calibrating a local oscillator of the UE 104).

The estimated position of the UE 104 may be determined at the location server 315 using the information communicated from the UE 104 and then transmitted back to the UE 104. Alternatively, the UE 104 may calculate the estimated position using assistance data from the location server 315 (e.g., Doppler frequency shifts for in-view GNSS satellites 493, positions and coverage areas of base stations, differential GPS data and/or altitude aiding information).

FIG. 6 shows another example of a hybrid positioning system. A UE 104 may communicate with the location server 315 via a base station 102 (e.g., a cellular base station) of a wireless network 621, a base station 102 (e.g., a cellular base station) of a wireless network 622, and/or a base station 102 (e.g., an access point) of a wireless network 623. A method for determining the estimated position of the UE 104 may use GNSS signals (e.g., from a satellite communication link 495 transmitted from GNSS satellites 493), wireless signals from base stations 102 of the wireless network 621 and wireless signals from base stations 102 of the wireless network 622. The wireless network 622 may be operated by a different service provider or use a different air interface than the wireless network 621.

Typically, a wireless LAN access point (such as the base station 102 of the wireless network 623 or other similar low power transmitters) has a small coverage area. When available, the small coverage area of such an access point provides a very good estimate of the position of the UE 104. Further, wireless LAN access points are typically located near or inside buildings, where the availability of other types of signals (e.g., GNSS signals or wireless telephone signals) may be low. Thus, when such wireless transmissions are used with other types of signals, the performance of the positioning system can be greatly improved.

The wireless signals from different wireless networks may be used for position determination. For example, the wireless signals from the different wireless networks can be used to determine the identities of the corresponding access points, which are then used to determine the locations and coverage areas of the corresponding access points. When precision range information (e.g., round-trip time or signal-traveling time between an access point and the UE 104) is available, the range information and the location of the access point can be used in obtaining a hybrid positioning solution. When approximate range information (e.g., received signal level, which can be approximately correlated with an estimated range) is available, the location of the access point can be used to estimate the position of the UE 104 (or to determine the estimated altitude of the UE 104). Further, the UE 104 can use a precision carrier frequency from one of the base stations 102 (e.g., from an access point), which may not be the base station 102 used for the data communication purpose, to calibrate a local oscillator of the UE 104.

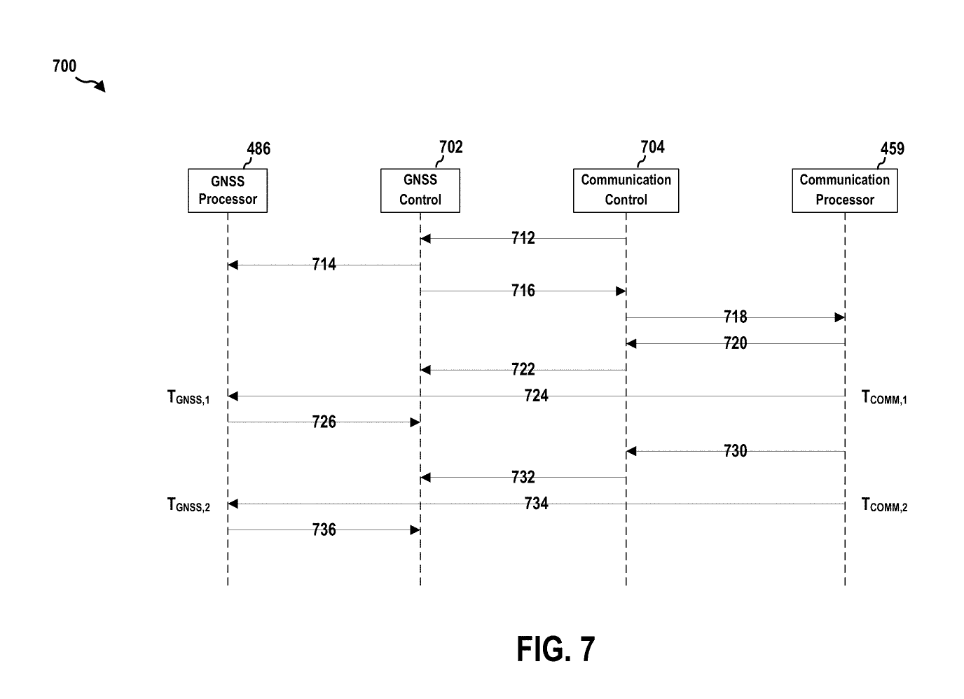

FIG. 7 is a diagram 700 illustrating a sequence of operations for synchronizing/correlating a communication system time with a GNSS system time of the UE 450. The communication processor 459 of the UE 450 is configured to execute communication firmware, which includes a communication control component 704. The GNSS processor 486 is configured to execute GNSS firmware, which includes a GNSS control component 702.

As described supra, the communication processor 459 is in communication with the oscillator 481 and determines a communication system time employed by the communication signal processing modules based on the oscillator 481. Further, in certain configurations, the communication system time may be in a GPS time format. That is, the system time is represented using a week number (WN) and a time of week count (TOW).

On the other hand, the GNSS processor 486 is in communication with the oscillator 483 and determines a GNSS system time employed by the GNSS processor 486, the GNSS receiver 484, etc. based on the oscillator 483. As the communication system time and the GNSS system time are determined based on two independent oscillators, the communication system time and the GNSS system time are also independent and are not synchronized or correlated. This, the system time of one system cannot be determined based on the system time of the other system. Therefore, the UE 104 employs the operations described infra to synchronize or correlate the two system times.

More specifically, at operation 712, the communication control component 704 sends a message to the GNSS control component 702 through a communication interface established between the communication control component 704 and the GNSS control component 702. The message instructs the GNSS control component 702 to open the GNSS processor 486, the GNSS receiver 484, the GNSS antenna 482, and other GNSS components (i.e., to switch those components to an operative state). Accordingly, at operation 714, the GNSS control component 702 sends one or more commands to the GNSS processor 486. The commands open the GNSS processor 486, and further requests the GNSS processor 486 to open the GNSS receiver 484, the GNSS antenna 482, etc. As such, the GNSS antenna 482, the GNSS receiver 484, and the GNSS processor 486 are operative and ready to measure a GNSS signal.

At operation 716, the GNSS control component 702 sends a request to the communication control component 704. The request asks the communication control component 704 to initiate a synchronization procedure. At operation 718, the communication control component 704 initiates the synchronization procedure. The communication control component 704 sends a command to the communication processor 459, instructing the communication processor 459 to operate in accordance with the synchronization procedure. Accordingly, at operation 720, the communication processor 459 determines a first time point at which the communication processor 459 will send a first synchronization signal to the GNSS processor 486 through the synchronization link 485. For example, as described infra, the communication control component 704 may decide that the first time point is a time point at which the communication control component 704 will receive a positioning reference signal or a frame boundary. Upon determining that it is at the first time point based on the oscillator 481, the communication processor 459 sends information regarding the first time point to the communication control component 704. The information includes a particular time mark T_{COMM,1} (e.g., Week X, TOW Y) of the communication system time representing the first time point. At operation 722, the communication control component 704 sends the information of the first time point to the GNSS control component 702. As such, the GNSS control component 702 learns that particular time mark of the communication system time, the particular time mark representing the first time point at which the communication processor 459 will transmit a synchronization signal to the GNSS processor 486 through the synchronization link 485.

Accordingly, at operation 724, the communication processor 459 sends, at the first time point as determined previously (i.e., represented by T_{COMM,1}), a synchronization signal to the GNSS processor 486. The GNSS processor 486, upon receiving the synchronization signal, records a particular time mark T_{GNSS,1}, of the GNSS system time. That is, the T_{COMM,1} and the T_{GNSS,1}, both correspond to the first time point. At operation 726, the GNSS processor 486 sends information regarding T_{GNSS,1}, to the GNSS control component 702. As such, the GNSS control component 702 can synchronize (correlate) the communication system time and the GNSS system time at the first time point. In other words, if given a particular time mark of one system time, the corresponding time mark of the other system time representing the same time point can be determined.

As described supra, the communication system time and the GNSS system time are determined based on the oscillator 481 and the oscillator 483, respectively. The frequencies of the oscillator 481 and the oscillator 483 may not be constant all the time and may have deviations from time to time. Thus, the synchronization or correlation established at the first time point may be lost after a period of time.

Therefore, the communication processor 459 may initiate the synchronization procedure in accordance with a schedule (e.g., periodically, every 1 second). In this example, the communication processor 459, at operation 730, determines a second time point at which the communication processor 459 will send a second synchronization signal to the GNSS processor 486 through the synchronization link 485. Upon determining the second time point, the communication processor 459 sends information regarding the second time point to the communication control component 704. The information includes a particular time mark T_{COMM,2} of the communication system time representing the second time point. At operation 732, the communication control component 704 sends the information of the second time point to the GNSS control component 702. As such, the GNSS control component 702 learns the T_{COMM,2}, which represents the second time point at which the communication processor 459 will transmit a synchronization signal to the GNSS processor 486 through the synchronization link 485.

Accordingly, at operation 734, the communication processor 459 sends, at the second time point, a synchronization signal to the GNSS processor 486. The GNSS processor 486, upon receiving the synchronization signal, records a particular time mark T_{GNSS,2} of the GNSS system time. That is, the T_{COMM,2} and the T_{TNSS,2} both correspond to the second time point. At operation 736, the GNSS processor 486 sends information regarding T_{GNSS,2} to the GNSS control component 702. As such, the GNSS control component 702 can synchronize (correlate) the communication system time and the GNSS system time at the second time point.

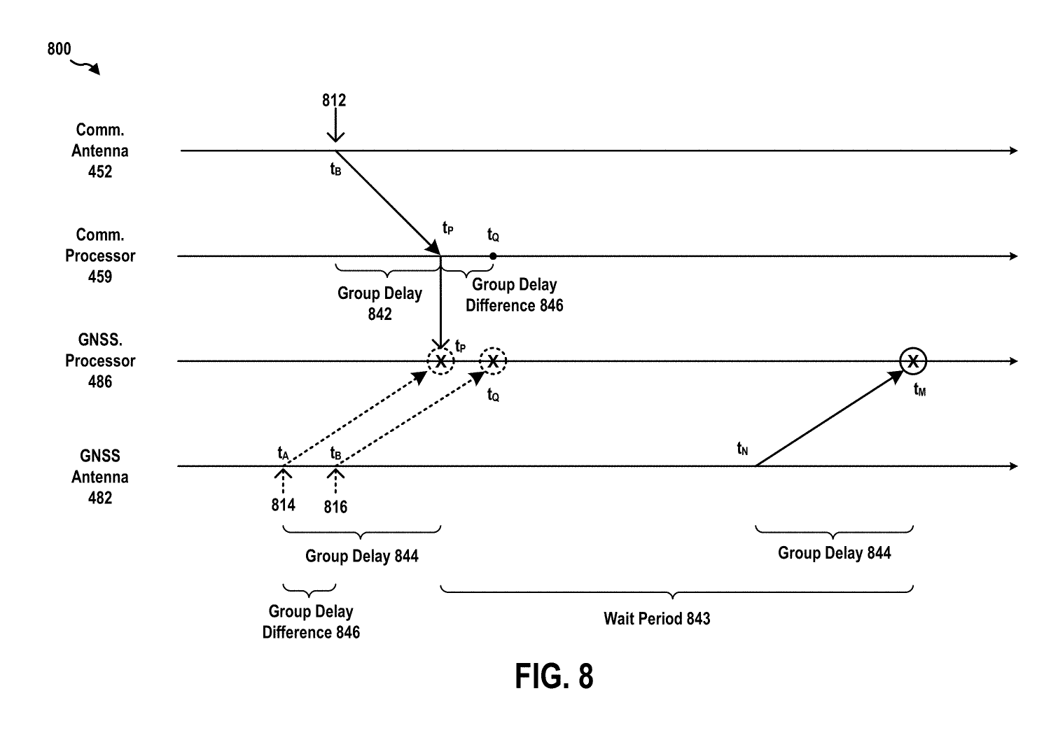

FIG. 8 is diagram 800 illustrating a UE that takes a communication signal measurement and a GNSS signal measurement within a small time period (e.g., 100, 200, 300, 500, 700, 900 nanoseconds, etc.). In this example, the communication antenna 452 of the UE 104 (or the UE 450) may receive, at a time point t_{B}, a frame boundary of a frame or a positioning reference signal 812 (e.g., Rₚ in FIG. 2A). As described infra, the UE 104 may obtain data carried in the frame or the positioning reference signal 812 for determining the position of the UE 104. Further, the UE 104 also operates to estimate a GNSS signal measurement at time point t_{B}. More specifically, in this example, the UE 450 receives the positioning reference signal 812 at the time point t_{B}. The communication processor 459 and communication control component 704, however, only receives data of the positioning reference signal 812 at a time point t_{P}, which is a period of a group delay 842 subsequent to the time point t_{B}. That is, the wireless communication component needs a time period of the group delay 842 to process a signal received at the communication antennas 452 to generate corresponding data.

When the communication control component 704 determines that the communication system time is at T_{COMM,P} (i.e., the time point t_{P}), at which the communication control component 704 receives the positioning reference signal 812 (or a frame boundary), the communication processor 459 sends a synchronization signal to the GNSS processor 486, using operations similar to operation 720 to operation 726 or operation 730 to operation 736 as described supra referring to FIG. 7. Upon detecting the synchronization signal at the GNSS processor 486, the GNSS control component 702 synchronizes (correlates) the communication system time with the GNSS system time at the time point t_{P}. More specifically, the GNSS control component 702 determines that a time mark T_{GNSS,P} of the GNSS system time, at which the GNSS processor 486 received the synchronization signal, corresponds to a time mark T_{COMM,P} of the communication system time, the information of which was sent to the GNSS control component 702 from the communication control component 704 in an operation similar to operation 722 and operation 732. Both time marks represent the time point t_{P}.

The GNSS control component 702 then initiates a procedure to take a GNSS signal measurement after a predetermined wait period 843 at a time point t_{M}, which is represented by a time mark T_{GNSS,M} of the GNSS system time. Accordingly, the GNSS component starts to process GNSS signals received at the GNSS antenna 482 and generates corresponding GNSS data. When the GNSS control component 702 determines that the GNSS system time is at T_{GNSS, M} based on the oscillator 481, the GNSS control component 702 records the GNSS data generated at that time point (i.e., the time point t_{M}). The GNSS component also needs a time period of a group delay 844 to process a signal received at the GNSS antenna 482 to generate corresponding data. Accordingly, the GNSS data recorded at T_{GNSS,M} are derived from the GNSS signals received at a time point t_{N} (represented as T_{GNSS,N}), which is a time period of the group delay 844 prior to the time point t_{M} (represented as T_{GNSS,M}).

Subsequently, the GNSS control component 702 extrapolates a GNSS signal measurement of the time point t_{P} (represented as T_{GNSS,P}) based on the GNSS signal measurement at the time point t_{M}. That is, the GNSS control component 702 estimate a GNSS signal measurement taken at the time point t_{P}. A GNSS signal carries, among other data, transmission time of the GNSS signal at a transmitting satellite. In one technique, to extrapolate the GNSS signal measurement of the time point t_{P} based on the GNSS signal measurement taken at the time point t_{M}, the GNSS control component 702 adjust the transmission time carried in each of the GNSS signal to a time point that is a time period of the group delay 844 prior to the transmission time.

The GNSS signal measurement taken at the time point t_{P} would be derived from a GNSS signal 814 received at the GNSS antenna 482 at a time point t_{A} (represented as T_{GNSS,A}), which is a time period of the group delay 844 prior to the time point t_{P} (T_{GNSS,P}). As such, the GNSS control component 702 has estimated a measurement of the GNSS signal 814 (which would be received at the GNSS antenna 482 at the time point t_{A}). Further, as described supra, the communication control component 704 has obtained data carried in the positioning reference signal 812 (which is received at the communication antennas 452 at the time point t_{B}). The time period between the time point t_{A} and the time point t_{B} is a group delay difference 846.

In certain configurations, the communication control component 704 can obtain or determine the group delay difference 846 in accordance with the communication system time. Accordingly, the communication control component 704 can determine time mark T_{COMM,Q} of a time point t_{Q}, which is a time period of the group delay difference 846 subsequent to the time point t_{P} represented by time mark T_{COMM,P}. The communication control component 704 can send information of T_{COMM,Q} to the GNSS control component 702. As the communication system time and the GNSS system time are synchronized at time point t_{P}, the GNSS control component 702 can determine a time mark T_{GNSS,Q} of the GNSS system time corresponding to T_{COMM,Q}.

The GNSS control component 702 then extrapolates a GNSS signal measurement of the time point t_{Q} based on the estimated GNSS signal measurement of the time point t_{P}. More specifically, the GNSS control component 702 adjust the estimated transmission time of the estimated GNSS signal measurement to a time point that is a time period of the group delay difference 846 subsequent to the estimated transmission time. As such, the GNSS control component 702 can obtain an estimated GNSS signal measurement of the time point t_{Q}. Further, the GNSS signal measurement taken at the time point t_{Q} would be derived from a GNSS signal 816 received at the GNSS antenna 482 at the time point t_{B} (represented as T_{GNSS,B}). The GNSS control component 702 sends the estimated measurement of the GNSS signal 816 (which would be received at the time point t_{Q}) to the communication control component 704.

As described supra, the communication control component 704 has obtained data that were carried in the positioning reference signal 812 being received at the communication antennas 452 at the time point t_{B}. The GNSS control component 702 has also obtained estimations of data that would be carried in the GNSS signal 816 being received at the GNSS antenna 482 at the time point t_{B}. As such, the communication control component 704 has obtained data of positioning reference signals and GNSS signals received at the same time point by the communication antennas 452 and GNSS antenna 482, respectively. Subsequently, the UE 104 can send those data to the location server 315 for further processing to determine the location of the UE 104.

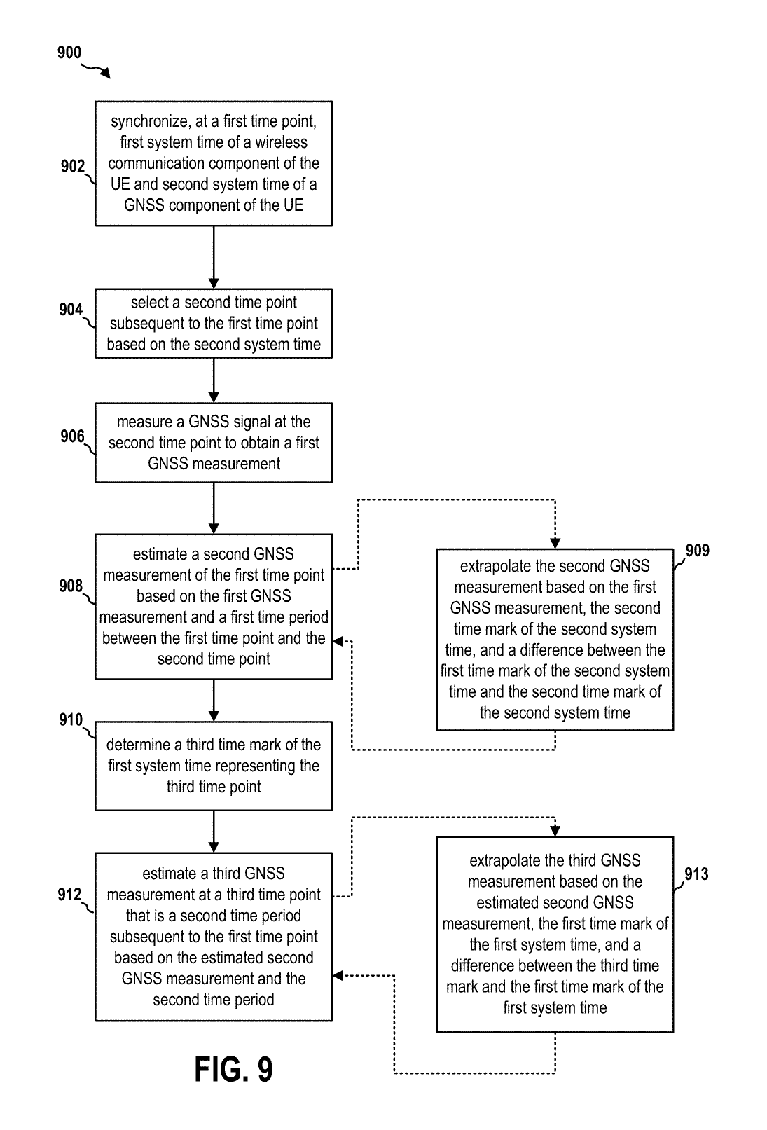

FIG. 9 is a flow chart 900 of a method (process) for estimating a GNSS signal measurement at a particular time point. The method may be performed by a UE (e.g., the UE 104, the UE 450, the apparatus 104′). At operation 902, the UE synchronizes, at a first time point, first system time of a wireless communication component of the UE and second system time of a GNSS component of the UE. Further, a first time mark of the first system time represents the first time point. For example, referring to FIG. 8, the UE 104 synchronizes the communication system time and the GNSS system time at the time point t_{P}. The time point t_{P}is represented by T_{COMM,P} of the communication system time and T_{GNSS,P} of the GNSS system time.

At operation 904, the UE selects a second time mark (e.g., T_{GNSS,M}) of the second system time, the second time mark representing a second time point subsequent to the first time point. At operation 906, The UE determines, based on an oscillator of the GNSS component, that it is at the second time mark. The UE further measures a GNSS signal at the second time point to obtain a first GNSS signal measurement. For example, referring to FIG. 8, the GNSS control component 702 takes a GNSS signal measurement when the GNSS system time is determined to be at T_{GNSS,M} (i.e., the time point t_{M}) based on the oscillator 483.

At operation 908, the UE estimates a second GNSS signal measurement of the first time point based on the first GNSS signal measurement and a first time period between the first time point and the second time point. In particular, in certain configurations, to estimate the second GNSS signal measurement, at operation 909, the UE extrapolates the second GNSS signal measurement based on the first GNSS signal measurement, the second time mark of the second system time, and a difference between the first time mark of the second system time and the second time mark of the second system time. For example, referring to FIG. 8, the GNSS control component 702 extrapolates the GNSS signal measurement of the time point t_{P} based on the GNSS signal measurement taken at the time point t_{M}, T_{GNSS,M} , and the wait period 843 between T_{GNSS,P} and T_{GNSS,M}.

Subsequent to operation 908, the UE, at operation 910, determines a third time mark (e.g., T_{COMM,Q}) of the first system time representing a third time point that is a second time period (e.g., the group delay difference 846) subsequent to the first time point. For example, referring to FIG. 8, the communication control component 704 selects T_{COMM,Q} that is the group delay difference 846 subsequent to T_{COMM,P}. At operation 912, the UE estimates a third GNSS signal measurement at the third time point based on the estimated second GNSS signal measurement and the second time period. The second time period is a difference between a group delay of the wireless communication component and a group delay of the GNSS component. In particular, to estimate the third GNSS signal measurement, at operation 913, the UE extrapolates the third GNSS signal measurement based on the estimated second GNSS signal measurement, the first time mark of the first system time, and a difference between the third time mark and the first time mark of the first system time. For example, referring to FIG. 8, the GNSS control component 702 extrapolates the GNSS signal measurement of the time point t_{Q} based on the estimated GNSS signal measurement of the time point t_{P}, T_{COMM,P} , and the group delay difference 846.

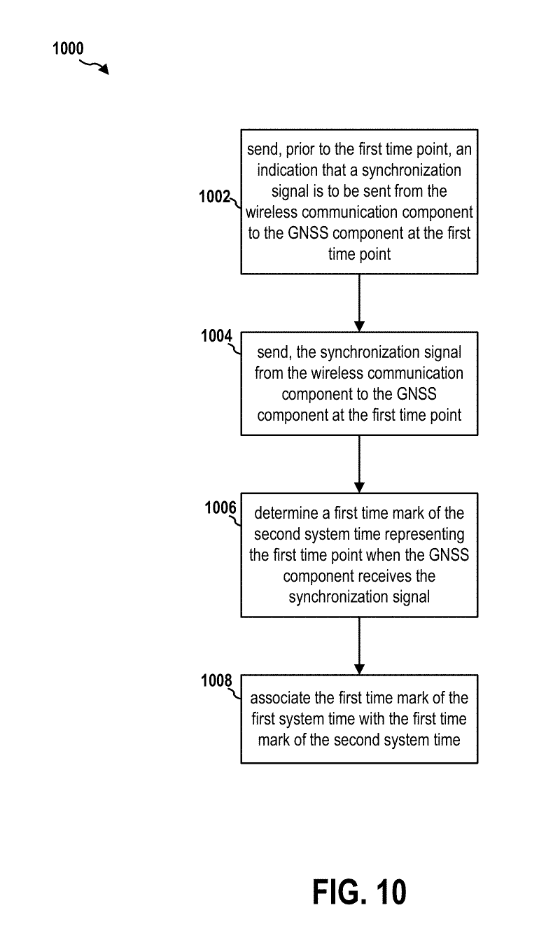

FIG. 10 is a flow chart 1000 of a method (process) for synchronizing/correlating a communication system time with a GNSS system time. The method may be performed by a UE (e.g., the UE 104, the UE 450, the apparatus 104′). In particular, in operation 902 of FIG. 9, to synchronize the first system time of the wireless communication component with the second system time of the GNSS component, at operation 1002, the UE sends, prior to the first time point, an indication that a synchronization signal is to be sent from the wireless communication component to the GNSS component at the first time point, the indication including a first time mark of the first system time representing the first time point. For example, referring to FIG. 7, at operation 722, the communication control component 704 sends the information of the first time point (e.g., T_{COMM,1}) to the GNSS control component 702.

At operation 1004, the UE sends the synchronization signal from the wireless communication component to the GNSS component at the first time point. For example, referring to FIG. 7, at operation 724, the communication processor 459 sends, at the first time point, a synchronization signal to the GNSS processor 486.

At operation 1006, the UE determines a first time mark of the second system time representing the first time point when the GNSS component receives the synchronization signal. For example, referring to FIG. 7, the GNSS processor 486, upon receiving the synchronization signal in operation 724, records a particular time mark T_{GNSS,1} of the GNSS system time. That is, the T_{COMM,1} and the T_{GNSS,1} both correspond to the first time point.

At operation 1008, the UE associates the first time mark of the first system time with the first time mark of the second system time. For example, referring to FIG. 7, at operation 726, the GNSS control component 702 synchronizes (correlates) the communication system time and the GNSS system time at the first time point.

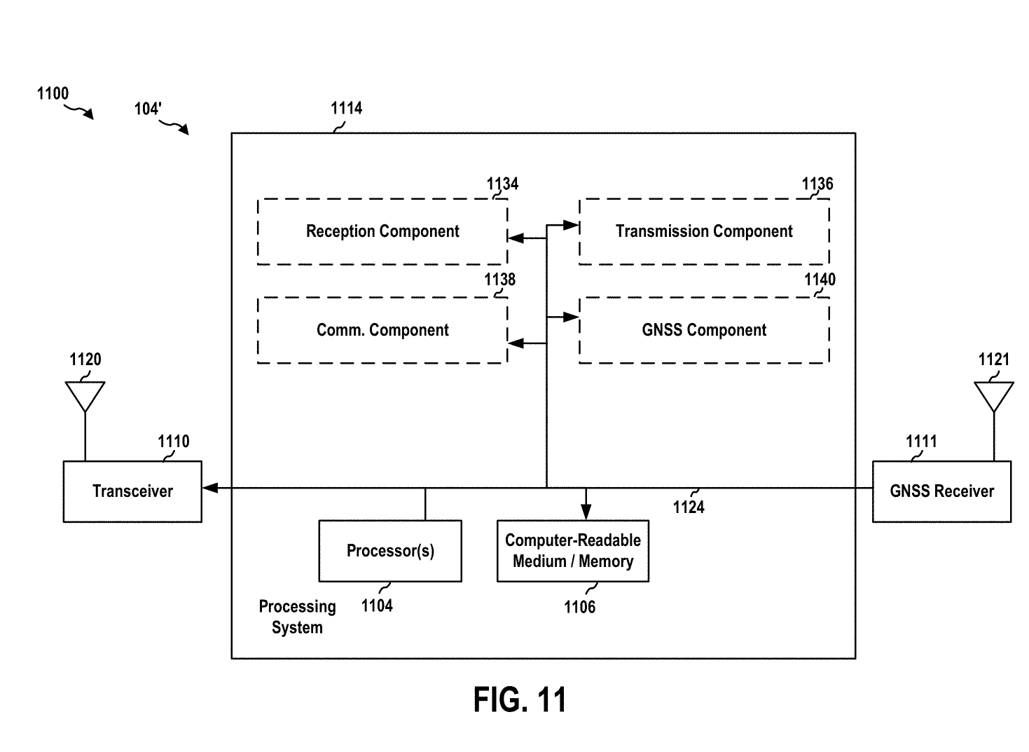

FIG. 11 is a diagram 1100 illustrating an example of a hardware implementation for an apparatus 104′ employing a processing system 1114. The processing system 1114 may be implemented with a bus architecture, represented generally by a bus 1124. The bus 1124 may include any number of interconnecting buses and bridges depending on the specific application of the processing system 1114 and the overall design constraints. The bus 1124 links together various circuits including one or more processors and/or hardware components, represented by one or more processors 1104, a reception component 1134, a transmission component 1136, a communication component 1138, a GNSS component 1140, and a computer-readable medium/memory 1106. The bus 1124 may also link various other circuits such as timing sources (e.g., the oscillator 481 and the oscillator 483), peripherals, voltage regulators, and power management circuits, etc.

The processing system 1114 may be coupled to a transceiver 1110, which may be one or more of the transceivers 454, and a GNSS receiver 1111, which may be the GNSS receiver 484. The transceiver 1110 is coupled to one or more antennas 1120, which may be the communication antennas 452. The GNSS receiver 1111 is coupled to one or more antennas 1121, which may be the GNSS antenna 482.

The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1134. In addition, the transceiver 1110 receives information from the processing system 1114, specifically the transmission component 1136, and based on the received information, generates a signal to be applied to the one or more antennas 1120.

The processing system 1114 includes one or more processors 1104 coupled to a computer-readable medium/memory 1106. The one or more processors 1104 are responsible for general processing, including the execution of software stored on the computer-readable medium/memory 1106. The software, when executed by the one or more processors 1104, causes the processing system 1114 to perform the various functions described supra for any particular apparatus. The computer-readable medium/memory 1106 may also be used for storing data that is manipulated by the one or more processors 1104 when executing software. The processing system 1114 further includes at least one of the reception component 1134, the transmission component 1136, the communication component 1138, the GNSS component 1140. The components may be software components running in the one or more processors 1104, resident/stored in the computer readable medium/memory 1106, one or more hardware components coupled to the one or more processors 1104, or some combination thereof. The processing system 1114 may be a component of the UE 450 and may include the memory 460 and/or at least one of the TX processor 468, the RX processor 456, the communication processor 459, and the GNSS processor 486.

In one configuration, the apparatus 104/104′ for wireless communication includes means for performing each of the operations of FIGS. 9-10. The aforementioned means may be one or more of the aforementioned components of the apparatus 104 and/or the processing system 1114 of the apparatus 104′ configured to perform the functions recited by the aforementioned means. As described supra, the processing system 1114 may include the TX Processor 468, the RX Processor 456, the communication processor 459, and the GNSS processor 486. As such, in one configuration, the aforementioned means may be the TX Processor 468, the RX Processor 456, the communication processor 459, and the GNSS processor 486 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.”As such, no claim element is to be construed as a means plus function unless the element is expressly recited using the phrase “means for.”

What is claimed is:

1. A method of wireless communication of a user equipment (UE), comprising:
synchronizing, at a first time point, first system time of a wireless communication component of the UE and second system time of a global navigation satellite system (GNSS) component of the UE;
measuring a GNSS signal at a second time point subsequent to the first time point to obtain a first GNSS signal measurement; and
estimating a second GNSS signal measurement of the first time point based on the first GNSS signal measurement and a first time period between the first time point and the second time point.

2. The method of claim 1, wherein the synchronizing comprises:
sending, prior to the first time point, an indication that a synchronization signal is to be sent from the wireless communication component to the GNSS component at the first time point, the indication including a first time mark of the first system time representing the first time point;
sending the synchronization signal from the wireless communication component to the GNSS component at the first time point;
determining a first time mark of the second system time representing the first time point when the GNSS component receives the synchronization signal; and
associating the first time mark of the first system time with the first time mark of the second system time.

3. The method of claim 2, further comprising:
determining, at the wireless communication component, that the first system time is at the first time mark based on an oscillator of the wireless communication component, wherein the synchronization signal is sent in response to the determination that the first system time is at the first time mark.

4. The method of claim 1, further comprising:
selecting a second time mark of the second system time, wherein the second time point is a time point represented by the second time mark of the second system time; and
determining, at the GNSS component, that the second system time is at the second time mark based on an oscillator of the GNSS component, wherein the GNSS signal is measured in response to the determination that the second system time is at the second time mark.

5. The method of claim 4, wherein the estimating the second GNSS signal measurement further comprises:
extrapolating the second GNSS signal measurement based on the first GNSS signal measurement, the second time mark of the second system time, and a difference between the first time mark of the second system time and the second time mark of the second system time.

6. The method of claim 1, further comprising:
estimating a third GNSS signal measurement at a third time point that is a second time period subsequent to the first time point based on the estimated second GNSS signal measurement and the second time period, wherein the second time period is a difference between a group delay of the wireless communication component and a group delay of the GNSS component.

7. The method of claim 6, wherein the estimating the third GNSS signal measurement further comprises:
determining a third time mark of the first system time representing the third time point; and
extrapolating the third GNSS signal measurement based on the estimated second GNSS signal measurement, the first time mark of the first system time, and a difference between the third time mark and the first time mark of the first system time.

8. An apparatus for wireless communication, the apparatus being a user equipment (UE), comprising:
a memory; and
at least one processor coupled to the memory and configured to:
synchronize, at a first time point, first system time of a wireless communication component of the UE and second system time of a global navigation satellite system (GNSS) component of the UE;
measure a GNSS signal at a second time point subsequent to the first time point to obtain a first GNSS signal measurement; and
estimate a second GNSS signal measurement of the first time point based on the first GNSS signal measurement and a first time period between the first time point and the second time point.

9. The apparatus of claim 8, wherein to synchronize the first system time with the second system time, the at least one processor is further configured to:
send, prior to the first time point, an indication that a synchronization signal is to be sent from the wireless communication component to the GNSS component at the first time point, the indication including a first time mark of the first system time representing the first time point;
send, the synchronization signal from the wireless communication component to the GNSS component at the first time point;
determine a first time mark of the second system time representing the first time point when the GNSS component receives the synchronization signal; and
associate the first time mark of the first system time with the first time mark of the second system time.

10. The apparatus of claim 9, wherein the at least one processor is further configured to:
determine, at the wireless communication component, that the first system time is at the first time mark based on an oscillator of the wireless communication component, wherein the synchronization signal is sent in response to the determination that the first system time is at the first time mark.

11. The apparatus of claim 8, wherein the at least one processor is further configured to:
select a second time mark of the second system time, wherein the second time point is a time point represented by the second time mark of the second system time; and
determine, at the GNSS component, that the second system time is at the second time mark based on an oscillator of the GNSS component, wherein the GNSS signal is measured in response to the determination that the second system time is at the second time mark.

12. The apparatus of claim 11, wherein to estimate the second GNSS signal measurement, the at least one processor is further configured to:
extrapolate the second GNSS signal measurement based on the first GNSS signal measurement, the second time mark of the second system time, and a difference between the first time mark of the second system time and the second time mark of the second system time.

13. The apparatus of claim 8, wherein the at least one processor is further configured to:
estimate a third GNSS signal measurement at a third time point that is a second time period subsequent to the first time point based on the estimated second GNSS signal measurement and the second time period, wherein the second time period is a difference between a group delay of the wireless communication component and a group delay of the GNSS component.

14. The apparatus of claim 13, wherein to estimate the third GNSS signal measurement, the at least one processor is further configured to:
determine a third time mark of the first system time representing the third time point; and
extrapolate the third GNSS signal measurement based on the estimated second GNSS signal measurement, the first time mark of the first system time, and a difference between the third time mark and the first time mark of the first system time.

15. A computer-readable medium storing computer executable code for wireless communication of a user equipment (UE), comprising code to:
synchronize, at a first time point, first system time of a wireless communication component of the UE and second system time of a global navigation satellite system (GNSS) component of the UE;
measure a GNSS signal at a second time point subsequent to the first time point to obtain a first GNSS signal measurement; and
estimate a second GNSS signal measurement of the first time point based on the first GNSS signal measurement and a first time period between the first time point and the second time point.

16. The computer-readable medium of claim 15, wherein to synchronize the first system time with the second system time, the code is further configured to:
send, prior to the first time point, an indication that a synchronization signal is to be sent from the wireless communication component to the GNSS component at the first time point, the indication including a first time mark of the first system time representing the first time point;
send, the synchronization signal from the wireless communication component to the GNSS component at the first time point;
determine a first time mark of the second system time representing the first time point when the GNSS component receives the synchronization signal; and
associate the first time mark of the first system time with the first time mark of the second system time.

17. The computer-readable medium of claim 16, wherein the code is further configured to:
determine, at the wireless communication component, that the first system time is at the first time mark based on an oscillator of the wireless communication component, wherein the synchronization signal is sent in response to the determination that the first system time is at the first time mark.

18. The computer-readable medium of claim 15, wherein the code is further configured to:
select a second time mark of the second system time, wherein the second time point is a time point represented by the second time mark of the second system time; and
determine, at the GNSS component, that the second system time is at the second time mark based on an oscillator of the GNSS component, wherein the GNSS signal is measured in response to the determination that the second system time is at the second time mark.

19. The computer-readable medium of claim 18, wherein to estimate the second GNSS signal measurement, the code is further configured to:
extrapolate the second GNSS signal measurement based on the first GNSS signal measurement, the second time mark of the second system time, and a difference between the first time mark of the second system time and the second time mark of the second system time.

20. The computer-readable medium of claim 15, wherein the code is further configured to:
estimate a third GNSS signal measurement at a third time point that is a second time period subsequent to the first time point based on the estimated second GNSS signal measurement and the second time period, wherein the second time period is a difference between a group delay of the wireless communication component and a group delay of the GNSS component.
